(19) United States
(12) Patent Application Publication
(10) Pub. No.: US 2012/0240210 A1
(43) Pub. Date: Sep. 20, 2012

(54) SERVICE ACCESS CONTROL

(75) Inventors: Robert Seidl, Konigsdorf (DE); Joerg Abendroth, Munich (DE); Markus Bauer-Hermann, Munich (DE)

(73) Assignee: NOKIA SIEMENS NETWORKS OY, Espoo (FI)

(21) Appl. No.: 13/511,192

(22) PCT Filed: Nov. 23, 2009
(86) PCT No.: PCT/EP09/65609

§ 371 Date: May 22, 2012

(51) Int. Cl. G06F 21/00

(52) U.S. Cl. 726/8; 726/5

(57) ABSTRACT

The invention enables a user to use single-sign-on methodologies to obtain access to a service where that user has more than one account. In addition to querying an identity provider to obtain user credentials in the usual way, the invention enables an application to request and obtain further credentials for that user in order to enable the user to gain access to the desired user account. The user may then be prompted to select which of the available accounts should be used at the application.

The present invention relates to authentication, service access control and identity management.

More and more services and applications are becoming available on the Internet or via other networks and many of these services and applications require user authentication. One approach that has been developed to assist users to access multiple services and applications, each requiring separate authentication procedures, involves the use of identity federation.

Federated identity management, or the “federation” of identity, describes technologies that serve to enable the portability of identity information across otherwise autonomous security domains. A goal of identity federation is to enable users of one domain to access data or systems of another domain seamlessly and securely, and without the need for redundant user administration. Eliminating the need for repeated login procedures each time a new application or account is accessed can substantially improve the user experience.

Security Assertion Markup Language (SAML) is an XML (eXtensible Markup Language) standard for exchanging authentication and authorisation data between security domains. For example, SAML is used for exchanging assertion data between an identity provider (a producer of assertions) and a service provider (a consumer of assertions). SAML is a specification defined by the OASIS (Organization for the Advancement of Structured Information Standards). Some embodiments of the invention may make use of OASIS features, but this is not essential to all embodiments of the invention.

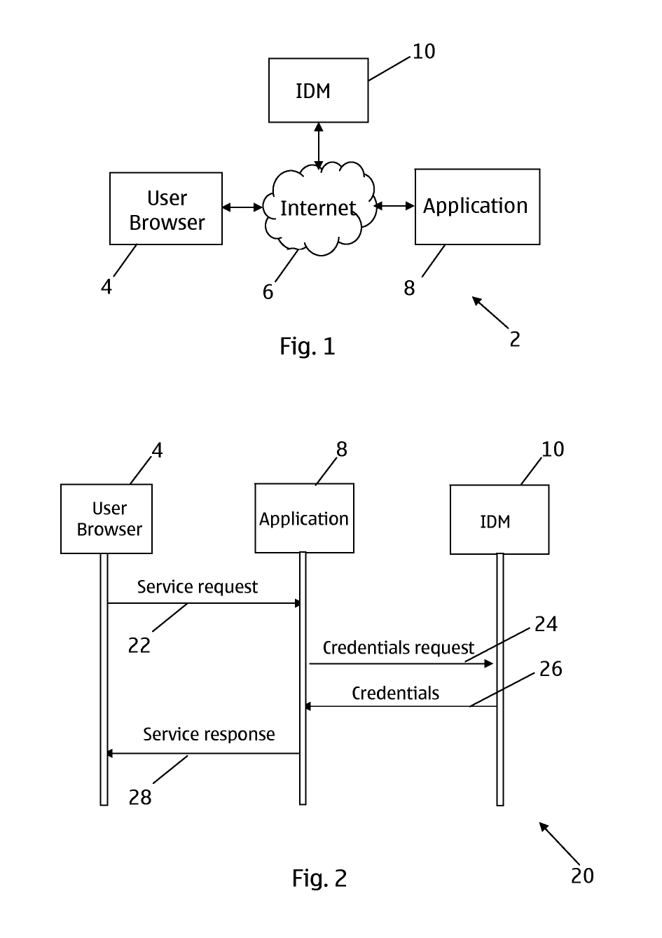

FIG. 1 is a block diagram, indicated generally by the reference numeral 2, showing a known system in which elements of the present invention may be used. The system 2 comprises a user browser 4, an application 8 and an identity provider 10. The user browser 4, application 8 and identity provider 10 are each coupled to the Internet 6, or some other network, and are able to communicate with each other via the Internet.

FIG. 2 is a message sequence, indicated generally by the reference numeral 20, showing an exemplary use of the system 2 to provide a user at the user browser 4 with access to the application 8. The message sequence 20 starts with a service access request 22 being sent from the user browser 4 to the application 8. The application 8 requires credentials for the user to be provided before granting the user access to the application. Accordingly, the application 8 sends a credentials request 24 to the identity provider 10. In response, the identity provider 10 provides a message 26 including user credentials to the application 8. Assuming that the user credentials are acceptable to the application 8, the application provides access to the user browser 4 in a service access message 28.

Mechanisms for implementing the credentials messages 24 and 26 are well known in the art. For example, the message 24 may be implemented using a SAML Request that is sent from the application 8 to the identity provider 10 via the user browser 4 using redirection. Similarly, the message 26 may be implemented using a SAML Response that is sent from the identity provider 10 to the application 8 via the user browser 4 using redirection. The skilled person will be aware of many alternative mechanisms that could be used.

The message sequence 20 can work well when a particular user has a single account at a particular application. However, this is not always the case.

There are many reasons why a user may have multiple accounts at a particular application. For example:

1. The user may be both an administrator and a user of a particular application or service.
2. The user may be acting as a stand-in for another user. For example, when a first user is on vacation, a second user may be given access to the first user's account for the duration of the vacation.
3. The user may have access to a personal bank account, a joint bank account with a partner, and the bank accounts of his or her children. All of those bank accounts may be provided by the same service provider.
4. In the case of registered mail, mail may be collected by a person other than the addressee of the mail. This might be a permanent arrangement or a temporary arrangement (e.g. to ensure that mail is received during a vacation).

The message sequence 20 does not enable a user with multiple accounts to control access to those accounts.

The present invention seeks to address at least some of the problems outlined above.

In accordance with an aspect of the invention, there is provided a method comprising: receiving first user credentials for a user; sending a request to an identity provider (typically either directly or using redirection) for additional credentials for the user; and receiving additional credentials data for the user. The additional credentials data for the user may comprise an indication that no additional credentials are stored for that user. Alternatively, the additional credentials data for the user may comprise additional user credentials for that user.

In accordance with an aspect of the present invention, there is provided a service provider comprising: a first input for receiving (e.g. from an identity provider) user credentials for a user; a first output for sending (to the identity provider) a request for additional credentials for the user (from the identity provider); and a second input for receiving additional credentials data for the user (in response to the request for additional credentials). In this (and all) embodiments of the invention described herein, different inputs may share the same physical inputs of a device, different outputs may share the same physical outputs of a device, and some inputs and outputs may share the same physical input-output of a device.

Thus, the invention enables a user to use single-sign-on methodologies to obtain access to a service where that user has more than one account. The invention enables the application to request and obtain further credentials for that user (if available) in order to enable the user to gain access to the desired user account.

The request for additional credentials for the user may be sent on request by the user. In an alternative embodiment, the additional credentials request is always performed.

Other alternatives exist, for example an additional credentials request could be issued for any user who has asked for an additional credentials request to be made before, or where the application is aware that the user has multiple accounts at the application (or has had in the past), or in specific circumstances, such as when the user is accessing an administrator account (indicating that the user may have a non-administrator account). A third input may be provided that is adapted to enable the user to request said additional credentials for the user. Thus, the user may be able to prompt a service provider to obtain additional credentials for the user, thereby enabling the user to obtain access to a different account at the application.

The invention may include presenting the user with a list of options (e.g. accounts) available to the user on the basis of the first credentials and the additional credentials for the user. The invention may include the user selecting one of the said options. For example, the options may relate to different bank accounts that the user has access to (e.g. a personal bank account, a joint bank account with a partner, a bank account of a child of the user etc.).

A second output may be provided that is adapted to provide a message enabling the user to be presented with a list of options (e.g. accounts) available to the user on the basis of the first credentials and the additional credentials for the user. For example, a user may request access to his email account. In response, the email server may prompt the user to indicate whether he wishes to access his own account, the account of his boss (which he has permanent access to) or the account of his colleague (which he has temporary access to whilst that colleague is on vacation).

A fourth input may be provided for receiving a selection (typically from the user) based on the list of options available to the user. Thus, the user may be able to indicate to the application, which of a number of available accounts he wishes to use.

The said first user credentials for the user may be provided by the identity provider (e.g. in a single-sign-on procedure).

In some forms of the invention, the first user credentials are obtained in response to a request by the user to access a service that requires user authentication.

In accordance with an aspect of the invention, there is provided a method comprising: receiving a request from a service provider for additional credentials for a user (typically a user logged-in at the service provider); determining whether additional credentials are stored (e.g. at an identity provider) for the user (e.g. in accordance with a policy); and providing an additional credentials response to the service provider.

In accordance with an aspect of the invention, there is provided an identity provider comprising: a first input for receiving a request from a service provider for additional credentials for a user (typically a user logged-in at the service provider); a first processor (or some other means) for determining whether additional credentials are stored for the user (e.g. in accordance with a policy); and a first output for providing an additional credentials response to the service provider.

The additional credentials response may comprise the determined additional credentials, in the event that such credentials are found. The additional credentials response may comprise simply an indication that no such additional credentials are found.

The additional credentials may be stored as a policy at an identity provider. A means may be provided for modifying the said policy. The invention may include means for providing or modifying stored additional credentials. For example, a policy defining such additional credentials may be stored at the identity provider and means may be provided for modifying the stored policy. Providing policies that can readily be modified at the identity provider provides control and flexibility for the users.

The additional credentials response may be dependent on the identity of the service provider.

In accordance with a further aspect of the invention, there is provided a computer program comprising: code (or some other means) for receiving first user credentials for a user; code (or some other means) for sending a request to an identity provider (typically either directly or using redirection) for additional credentials for the user; and code (or some other means) for receiving additional credentials data for the user. The computer program may be a computer program product comprising a computer-readable medium bearing computer program code embodied therein for use with a computer.

In accordance with a further aspect of the invention, there is provided a computer program comprising: code (or some other means) for receiving a request from a service provider for additional credentials for a user (typically a user that is logged-in at the service provider); code (or some other means) for determining additional credentials for the user (typically in accordance with a policy); and code (or some other means) for providing the determined additional credentials to the service provider. The computer program may be a computer program product comprising a computer-readable medium bearing computer program code embodied therein for use with a computer.

Embodiments of the invention are described below, by way of example only, with reference to the following schematic drawings.

FIG. 1 is a block diagram of a system in which the present invention may be used;

FIG. 2 is a message sequence showing a use of the system of FIG. 1;

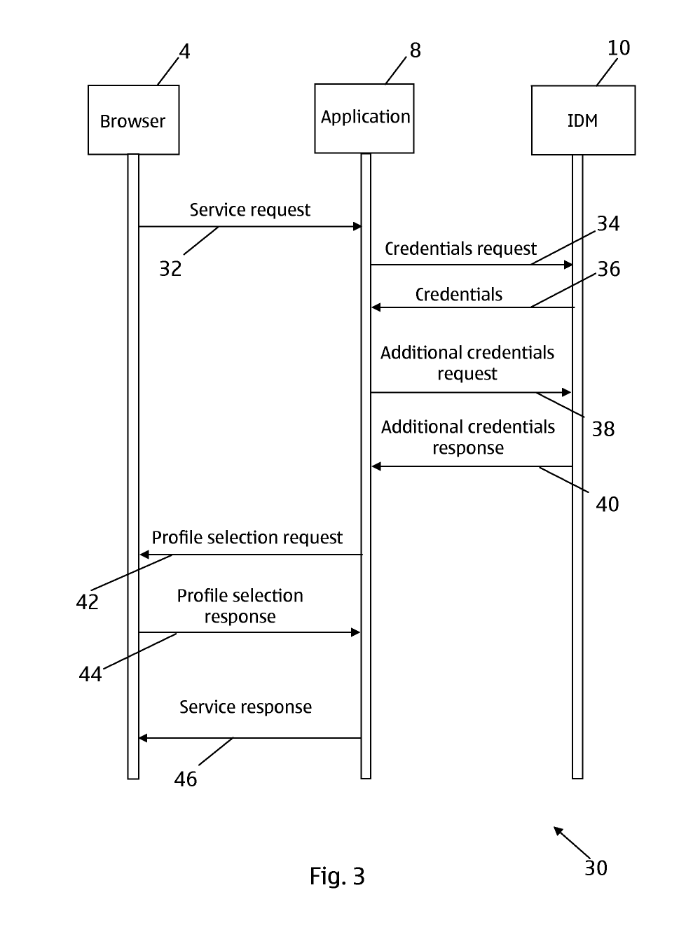

FIG. 3 is a message sequence showing an exemplary use of the system of FIG. 1 in accordance with a first aspect of the present invention; and

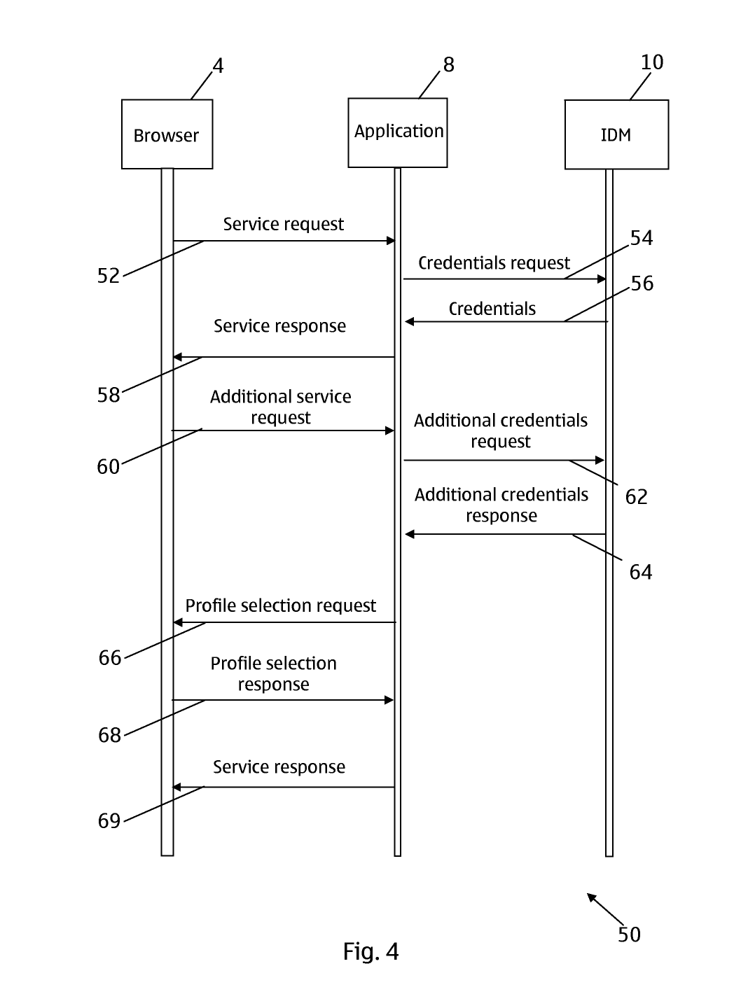

FIG. 4 is a message sequence showing an exemplary use of the system of FIG. 1 in accordance with a second aspect of the present invention.

FIG. 3 is a message sequence, indicated generally by the reference numeral 30, showing an exemplary use of the system 10 in accordance with an exemplary embodiment of the present invention. The message sequence 30 starts with a service access request 32 sent from the user browser 4 to the application 8. The application 8 requires credentials for the user to be provided before granting the user access to the application. Accordingly, the application 8 sends a credentials request 34 to the identity provider 10. In response, the identity provider 10 provides a message 36 including user credentials to the application 8. Accordingly, the messages 32, 34 and 36 are the same as the messages 22, 24 and 26 of the message sequence 20 described above. As described above with reference to the message sequence 20, the messages 34 and 36 may be transmitted via the user browser 4 using redirection and may be SAML Request and SAML Response messages respectively.

In the message sequence 30, on receipt of the credentials messages 36, the application 8 asks the identity provider to indicate whether there are any further user credentials stored at the identity provider for that user that might be relevant. Thus, the application 8 can determine whether the user has more than one account at the application.

Thus, on receipt of the credentials message 36, the application 8 requests additional credential information for the user. This request is implemented by sending an additional credentials request 38 to the identity provider 10. The message 38 may be sent directly from the application 8 to the identity provider 10. Alternatively, the message 38 may be sent from the application 8 to the identity provider 10 via the user browser 4 using redirection.

The message 38 might contain the following information:
an indication of the issuer (i.e. identifying the application 8); and
a subject (i.e. identifying the user at the user browser 4).

In addition, the message might contain further information, such as:
a specific context (for which special functions of the service may the user act as a different person); and
a specific date range (between which dates may the user act as a different person).

In response to receiving the additional credentials message 38, the identity provider 10 checks the user's profile stored at the identity provider to determine whether the user has any further accounts at the application 8. If so, the identity provider 10 checks the user's policies to determine what information should be provided to the application 8.

The identity provider 10 prepares a response to the request 38 depending on the user data and policies stored at the identity provider and sends that response to the application 8 as an additional credentials response 40. By way of example, an exemplary policy stored at a particular user's identity provider may have the following rules:

1. User “colleague A” can answer my emails from 1 Nov. 2009 to 20 Nov. 2009.
2. User “colleague B” can access a tool called “MyWorkTool” in my name from 10 Nov. 2009 to 20 Nov. 2009.
3. My wife can access my bank account at any time.
4. My secretary can post information to my social networking site, at any time, using my name.

The additional credentials response 40 might, for example, contain only a “success status” signal in the event that the user has no further accounts at the application 8. The additional credentials response 40 may also contain a list of subjects under which the user is also known at the application 8 and may further contain further information, such as an indication that a particular account of the user is only temporary.

In the message sequence 30, it is assumed that the additional credentials response 40 reveals that the user at the user browser 4 has multiple accounts at the application 8. In response to receiving this information, the application 8 prompts the user to indicate which account should be used. This is achieved by sending a profile selection request 42 from the application 8 to the user browser 4. The profile selection request 42 may instruct the browser to display a prompt to the user. In response to the request 42, the user indicates which account should be used and this is sent as a profile selection response 44 from the browser 4 to the application 8.

Of course, if the user has only one account at the application 8, then the steps 42 and 44 might be omitted. Also, even in the event that the user has multiple accounts at the application, the application 8 and/or the identity provider 10 may decide which account should be used, such that the messages 42 and 44 may be omitted. Furthermore, there are many other ways in which account selection could be informed. For example, there may be a policy that indicates that when a user is using a particular device to access the application 8, then a particular account should be preferred. Also, a user could select between accounts using an InformationCard.

At this stage, the application 8 has received an indication of which user account should be used. The user credentials for that account can be checked and, if the credentials are appropriate, access to the service is granted to the user and this is confirmed in a service response 46 that is sent from the application 8 to the browser 4.

It should be noted that the various messages shown in the message sequence 30 do not necessarily need to follow immediately one after the after; rather, there may be a significant delay between some of the messages. For example, there may be a delay between the user credentials being received in message 36, and additional user credentials being requested in message 38. One possible reason for this, as discussed below with reference to FIG. 4, is that the additional credentials request 40 might only be sent in response to a user prompt. However, there are other possible reasons for delays.

In some forms of the invention, the additional credentials request 38 is always sent, regardless of the identity of the user. In other forms of the invention, the additional credentials request 38 is sent only when the application 8 has some reason for suspecting that the user may have additional credentials. This may be, for example, because the same user has previously used different user credentials, because the user has previously indicated that he has multiple user credentials, or because the user has indicated in the service request 32 that he has multiple user credentials. Of course, other scenarios are possible. For example, in the event that an administrator logs into an application, the application can issue an additional credentials request simply because it is quite common for an administrator to have a separate user account at such a service.

As discussed above, there are many reasons why a user might have multiple accounts at a particular service provider or application. The use of the present invention in some of the scenarios referred to above is discussed below.

In the event that the user is both an administrator and a user of a particular application or service, the profile selection request 42 might ask the user to indicate whether he wants to access the application 8 in his capacity as a user or in his capacity as an administrator. Alternatively, the initial service request 32 might indicate that the user wishes to access the application 8 in a particular mode. In that event, the application 8, on receiving multiple account details, can simply select the appropriate account and the messages 42 and 44 are not required.

Similarly, in the event that the user has access to a personal bank account, a joint bank account with a partner, and the bank accounts of his or her children, the profile selection request 42 may simply prompt the user to indicate which bank account he wishes to access.

In the event that the user is acting as a stand-in for another user whilst that other user is on vacation, the profile selection request 42 might ask the user to indicate whether he wants to access his own account or the account of the user that is on vacation. An advantage of the present invention is the delegation permissions, such as email access when a user is on vacation, can be readily granted and revoked at the identity provider 10, as required. There is no need for either user to interact directly with the application. A further advantage is that delegated authority can be passed along a chain of users. For example, consider the situation where users A and B both grant user C access to their email inbox. This can readily be recorded at the identity provider 10. Consider now that the user C is unavailable on a particular day. The user C can readily delegate access to his own email inbox and the inbox of user A to user D, whilst delegating access to user B's inbox to user E. Thus, the present invention provides a significant amount of flexibility.

FIG. 4 shows a message sequence, indicated generally by the reference numeral 50, showing an exemplary use of the system 10 in accordance with an alternative embodiment of the present invention. The message sequence 50 starts with a service access request 52 being sent from the user browser 4 to the application 8. The application 8 requires credentials for the user to be provided before granting the user access to the application. Accordingly, the application 8 sends a credentials request 54 to the identity provider 10. In response, the identity provider 10 provides a message 56 including user credentials to the application 8.

In the message sequence 50, on receipt of the credentials message 56, the application 8 checks the user credentials and, if they are acceptable, provides the user with access to the application 8 and indicates this in a message 58 provided to the user browser 4. Accordingly, the messages 52, 54, 56 and 58 are the same as the messages 22, 24, 26 and 28 of the message sequence 20 described above with reference to FIG. 2.

At some point, the user indicates that an alternative account should be used at the application 8. The user may, for example, press a button at the browser 4. In response to this indication from the user, an additional service request message 60 is sent from the user browser 4 to the application 8.

On receipt of the additional service request 60, the application 8 requests additional credentials information for the user. This request is implemented by sending an additional credentials request 62 to the identity provider 10. The message 62 may be the same as the message 38 described above.

In response to receiving the additional credentials message 62, the identity provider 10 checks the user's profile stored at the identity provider to determine whether the user has any further accounts at the application 8. If so, the identity provider 10 checks the user's policies to determine what information should be provided to the application 8.

The identity provider 10 prepares a response to the request 62 depending on the user data and policies stored at the identity provider and sends that response to the application 8 as an additional credentials response 64. The additional credentials response 64 may be the same as the additional credentials response 40 described above.

In the event that the message 64 indicates that the user has multiple accounts at the application 8, the application 8 prompts the user to indicate which account should be used. This is achieved by sending a profile selection request 66 from the application 8 to the user browser 4. The profile selection request 66 may instruct the browser to display a prompt to the user. In response to the request 66, the user indicates which account should be used and this is sent as a profile selection response 68 from the browser 4 to the application 8. Thus, the messages 66 and 68 may be the same as the messages 42 and 44 described above. As discussed above with reference to FIG. 3, in some forms of the invention, the messages 66 and 68 may be omitted.

At this stage, the application 8 has received an indication of which user account should be used. The user credentials for that account can be checked and, if the credentials are appropriate, access to the service is granted to the user and this is confirmed in a service response 69 that is sent from the application 8 to the browser 4.

The embodiments of the invention described above are illustrative rather than restrictive. It will be apparent to those skilled in the art that the above devices and methods may incorporate a number of modifications without departing from the general scope of the invention. It is intended to include all such modifications within the scope of the invention insofar as they fall within the scope of the appended claims.

1. A method comprising:
receiving first user credentials for a user;
sending a request to an identity provider for additional credentials for the user; and
receiving additional credentials data for the user.

2. A method as claimed in claim 1, wherein sending a request for additional credentials for the user is performed on request by the user.

3. A method as claimed in claim 1, wherein said first user credentials for the user are provided by the identity provider.

4. A method as claimed in claim 1, further comprising presenting the user with a list of options available to the user on the basis of the first credentials and the additional credentials data for the user.

5. A method as claimed in claim 1, further comprising receiving an indication from the user regarding which of a plurality of available user accounts should be used.

6. A method as claimed in claim 1, wherein the first user credentials are obtained in response to a request by the user to access a service that requires user authentication.

7. A method comprising:
receiving a request from a service provider for additional credentials for a user;
determining whether additional credentials are stored for the user; and
providing an additional credentials response to the service provider.

8. A service provider comprising:
a first input for receiving user credentials for a user;
a first output for sending a request for additional credentials for the user; and
a second input for receiving additional credentials data for the user.

9. A service provider as claimed in claim 8, further comprising a third input adapted to enable the user to request said additional credentials for the user.

10. A service provider as claimed in claim 8, further comprising a second output for providing a message enabling the user to be presented with a list of options available to the user on the basis of the first credentials and the additional credentials data for the user.

11. An identity provider comprising:
a first input for receiving a request from a service provider for additional credentials for a user;
a first processor for determining whether additional credentials are available for the user; and
a first output for providing an additional credentials response to the service provider.

12. An identity provider as claimed in claim 11, wherein the additional credentials response is dependent on the identity of the service provider.

13. An identity provider as claimed in claim 11, further comprising means for providing or modifying the additional credentials stored for a user.

14. A computer program product comprising:
means for receiving first user credentials for a user;
means for sending a request to an identity provider for additional credentials for the user; and
means for receiving additional credentials data for the user.

15. A computer program product comprising:
means for receiving a request from a service provider for additional credentials for a user;
means for determining whether additional credentials are available for the user; and
means for providing the determined additional credentials to the service provider.
